(19) United States
(12) Patent Application Publication
(10) Pub. No.: US 2016/0061692 A1
(43) Pub. Date: Mar. 3, 2016

(54) ROLLER TESTING STATION FOR MOTOR VEHICLES

(71) Applicant: Actia CZ s.r.o., Tabor (CZ)

(72) Inventors: Josef HOREJSI, Oparany (CZ); Frantisek MASAT, Tabor (CZ); Petr FREITAG, Chynov (CZ); Vaclav HRUDKA, Kolin (CZ)

(73) Assignee: Actia CZ s.r.o.

(21) Appl. No.: 14/833,417

(22) Filed: Aug. 24, 2015

(30) Foreign Application Priority Data
Aug. 27, 2014 (CZ) PUV2014-29913

(51) Int. Cl. G01M 17/007

(52) U.S. Cl. CPC G01M 17/0074

(57) ABSTRACT

The technical design relates to a roller testing station (1) for a motor vehicle (2) comprising at least one fixed roller (3) for rolling at least one driven wheel (4) of the motor vehicle (2) driven by a motor (5). A roller testing station (1) further comprising at least one braking means, at least one cooling means for cooling the parts of the motor vehicle (2) during the test, and at least one sensing means (6) for monitoring and recording parameters and test results. In the new technical design the braking means comprises at least one fan (7) interconnected with the fixed roller (3) by at least one of gear for transferring the rotational motion of the fixed roller (3) to the fan (7).

### FIELD OF THE INVENTION

The technical design relates to a roller testing station designed for applying mechanical load to the motor of a motor vehicle.

### BACKGROUND OF THE INVENTION

Presently, for applying mechanical load to the motor of a motor vehicle, testing stations are used which include a fixed testing roller along which the wheel of the motor vehicle is rolled, driven by a motor. The fixed roller is connected to a retarder which, through the process of braking, takes energy from the system of fixed roller and driven wheel, wherein the rate of braking is programmatically controlled. Testing stations require the engine and the retarder to be cooled. The degree of load is monitored using dynamometers and other suitably selected sensors, according to the results of which the induced conditions are monitored and the test results are recorded.

The disadvantages of this design lie in the need to ensure the cooling of the motor and the retarder. Further disadvantages lie in the fact that the retarder must include brakes, which increases the weight of the entire testing station; the brakes of the retarder are typically electromagnetic to prevent friction which is accompanied by waste heat, therefore the testing stations must be connected to a voltage source. During the process of braking by the retarder with mechanical brakes, heat is produced which must be dissipated outside the station by a cooling circuit. During the test, the motor of the vehicle heats up but is not simultaneously cooled by flowing air, as was intended in the construction of the motor vehicle, because the motor vehicle remains in place. Also, the force of friction between the tire and the casing of the fixed roller causes the tire to heat up, thereby causing it wear and possibly permanently damaging it. Cooling circuits used complicate the testing station's construction again, and the testing station is not transportable.

The objective of the invention is to create a roller testing station which would remedy the aforementioned disadvantages and which should be of a transportable and simple construction.

### ESSENCE OF THE INVENTION'S DESIGN

This objective is achieved by a roller testing station produced according to this invention.

The roller testing station for motor vehicles comprises at least one fixed roller. The fixed roller serves for rolling at least one driven wheel of the motor vehicle driven by a motor. It further comprises at least one braking means, at least one cooling means for cooling the parts of the motor vehicle, and at least one sensing means for monitoring and recording the parameters and results of the tests carried out.

The essence of the invention consists in that the braking means comprises at least one fan connected to the fixed roller by means of at least one gear for transferring the rotational motion from the fixed roller to the fan. The air resistance applied on the rotating fan blades is variable depending on the speed of rotation of the fan blades.

In another preferred embodiment of the roller testing station according to the present invention, there are created two gears between the fixed roller and the fan with mutually different gear ratios, wherein both gears are high range and are switchable using a clutch provided with a lever for changing gears. The gear with lower gear ratio simulates the ride in the vehicle on the road with a driver, while the gear with higher gear ratio increases the load in extreme cases.

In another preferred embodiment of the roller testing station according to the present invention, each of the gears is formed by a sprocket wheel arranged on the axis of rotation of the fixed roller, and the sprocket wheel is arranged on the axis of rotation of the fan and a drive chain. The sprocket wheel and the drive chain have higher reliability than ordinary belts which could slip during a sudden change in speed.

In another preferred embodiment of the roller testing station according to the present invention, the fan is centrifugal. This means that the intake of air is parallel to the axis of rotation of the fan, while the output of the air is perpendicular to the axis of rotation of the fan. A centrifugal fan can be more easily incorporated into the station. The fixed roller and the fan are arranged in parallel in a common housing, wherein the fixed roller partly extends from the housing for contact with the driven wheel of the motor vehicle. The housing protects the station operator from injury, since this is a machine operating at high rotational speeds, which are the most dangerous in workplaces. The housing also directs the driven air and is therefore encased except for the part of the surface of the fixed roller where the driven wheel of the vehicle is placed. Perpendicular to the axis of rotation of the fan there is formed, in the housing, at least one suction opening, and at least one air outlet is also formed in the housing.

In another preferred embodiment of the roller testing station according to the present invention, the exhaust air from the fan is guided by at least one pipe connected at one end to at least one air outlet and at its other end is directed at the motor of the motor vehicle. Simultaneously, the outlet air from the fan is guided by at least one air duct to the tire of the driven vehicle wheel. The roller testing station does not require external cooling means, because the flow of the air from the fan is able to adequately cool the motor and tire of the vehicle. This makes the entire station structurally simpler and lowers its manufacturing costs.

In another preferred embodiment of the roller testing station according to the present invention, the sensing means comprises at least one device from the following group: a tachometer for the fixed roller, an infrared thermometer for measuring the temperature of the tire of the driven wheel of the vehicle, an infrared thermometer for measuring the temperature of the motor, a tachometer for the motor of the vehicle, and a sensor for measuring the temperature of the intake air. The sensing means monitor certain parameters of the test and ensure the safety of the tests being carried out. It is also necessary to record the results of the measurements taken during the test.

In another preferred embodiment of the roller testing station according to the present invention, the roller testing station is provided with two fixed rollers for carrying out performance tests on motor load in two-track motor vehicles. Even cars that do not have merely passive cooling for the motor, as motorcycles do, should be cooled during the tests.

The advantages of the roller testing station according to the invention include the possibility of rapidly obtaining performance parameters on the crankshaft of the motor, i.e. the course of torque and power in dependence on motor speed.

The advantages of the roller test station according to the invention also include a simple structure suitable for mobile testing stations, economic execution of the test with cooling for the motor vehicle, in which air from the fan is used for cooling, as well as the possibility of adjusting the test parameters with the switchahle gears.

### DESCRIPTION OF THE DRAWINGS

The invention shall be more clearly described using illustrations, in which

FIG. 1 shows an axonotnetric view of a single-track motor vehicle on the roller test station,

FIG. 2 shows a detailed view of a gear with lower gear ratio between the fixed roller and the fan,

FIG. 3 shows a detailed view of a gear with higher gear ratio between the fixed roller and the fan,

FIG. 4 schematically illustrates the roller testing station for a two-wheeled vehicle, and

FIG. 5 schematically illustrates the roller testing station for two-track vehicles.

### EXAMPLES OF THE EMBODIMENT OF THE DESIGN

It is understood that the hereinafter described and illustrated specific examples of the realization of the invention are presented for illustrative purposes and not as a limitation of the examples of the realization of the invention to the cases shown herein. Experts who are familiar with the state of technology shall find, or using routine experimentation will be able to determine, a greater or lesser number of equivalents to the specific realizations of the invention which are specifically described here. These equivalents shall also be included into the scope of the patent claims.

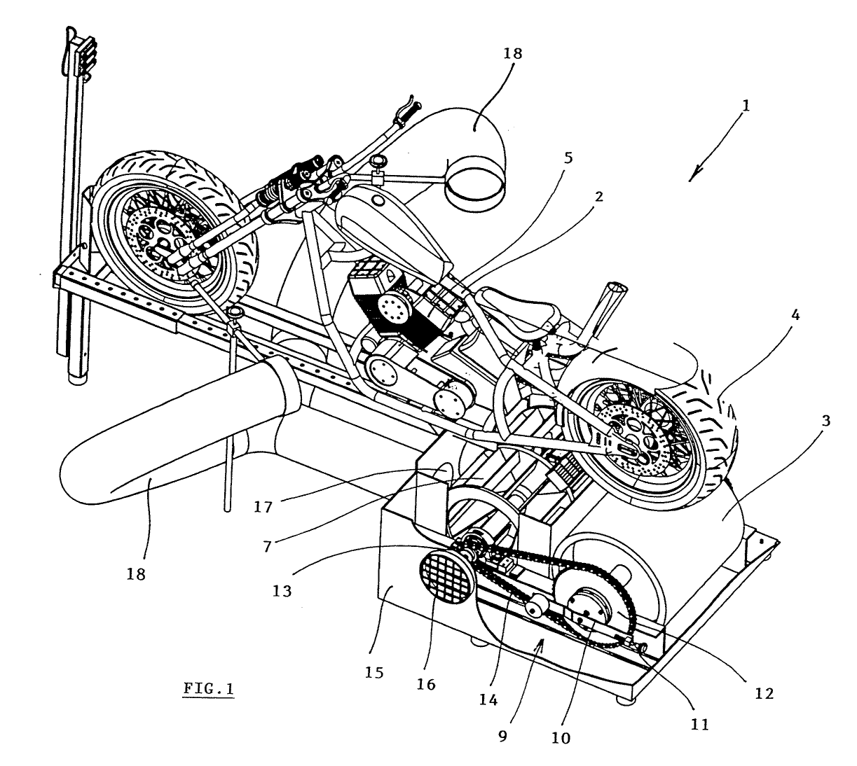

FIG. 1 shows a roller testing station 1 for a single-track motor vehicle 2. The roller testing station 1 is mechanically loaded by the motor 5 of the motor vehicle 2. The roller testing station 1 includes a fixed roller 3 which is made of steel. Its weight is concentrated on its periphery for the purpose of influencing the resulting value of the moment of inertia of the fixed roller 3.

For mechanically loading the motor vehicle 2, the roller testing station 1 is provided with a centrifugal fan 7. The fan 7 is concealed in the sheet metal encasing of the housing 15 of the roller testing station 1. In the encasing of the housing 15 there are located two intake openings 16 for drawing air in to the blades of the fan 7 and two air outlets 18 through which the flowing air leaves from the fan 7. The intake openings 16 are located in the axis of rotation of the fan 7 while the air outlet 17 is located perpendicularly to the axis of rotation of the fan 7.

On the fixed roller 3 there abuts and presses the driven wheel 4 of the motor vehicle 2. The power of the motor 5 is transmitted to the driven wheel of the vehicle 4 which turns the fixed roller 3. The driven wheel 4 is encased by a tire. Between the driven wheel 4 and the fixed roller 3, heat is released as an accompanying effect of the present friction. For cooling the tires of the driven wheel 4, there is led from the fan 7 an air duct 19, through which air flows to the tire of the driven wheel 4 and the fixed roller 3. The air duct 19 is formed by an opening in the encasing of the housing 15 of the roller testing station 1. For monitoring the degree of heating of the driven wheel 4, there is installed a sensing means 6 consisting of an infrared thermometer at the point of contact with the fixed roller 3.

Because when the motor vehicle 2 is standing in place there is no proper cooling of the motor 5, this cooling is implemented by two cooling ducts 18 which are mounted on two air outlets 17 and directed at their other ends to the motor 5.

The fan 7 is connected to the fixed roller 3 by two different gears 8 and 9 which are switchable so that only one of them transmits the power from the fixed roller 3 to the fan 7. The switching between gears 8 and 9 is secured by a clutch 10.

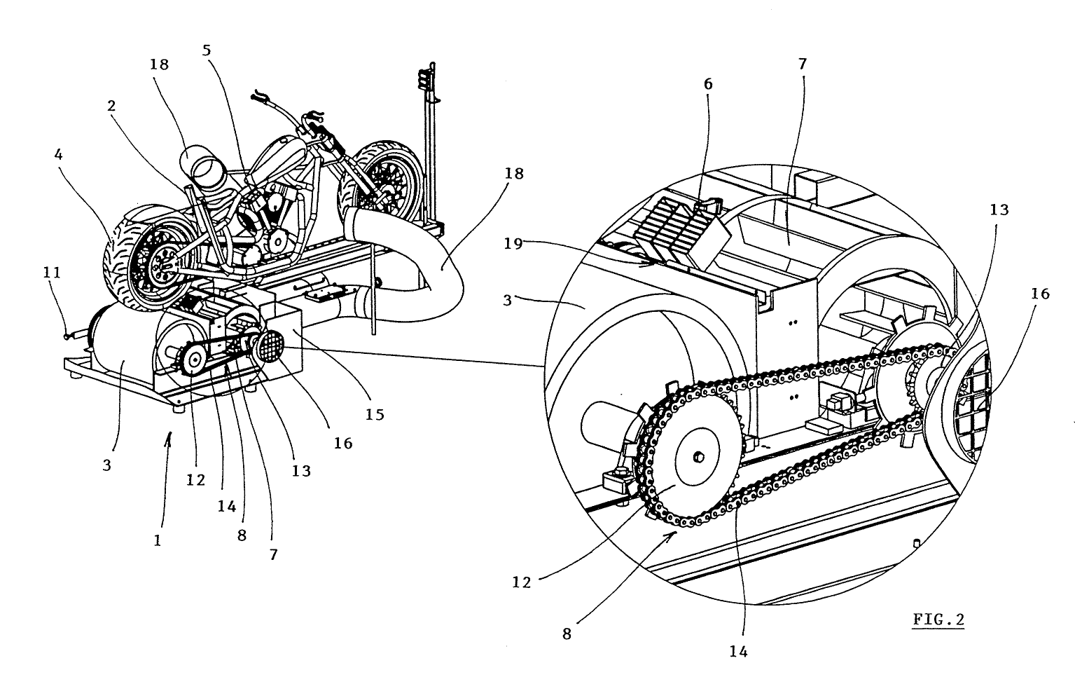

FIG. 2 shows a detailed representation of a gear with lower gear ratio 8 which comprises a sprocket wheel 12 mounted on the axis of rotation of the fixed roller 3, a sprocket wheel 13 mounted on the axis of rotation of the fan 7 and the drive chain 14 mounted on both sprocket wheels 12 and 13. The difference between the diameters of the two sprocket wheels 12 and 13 is small, and therefore the rotation speed of the fan 7 is only slightly higher than the rotation speed of the fixed roller 3.

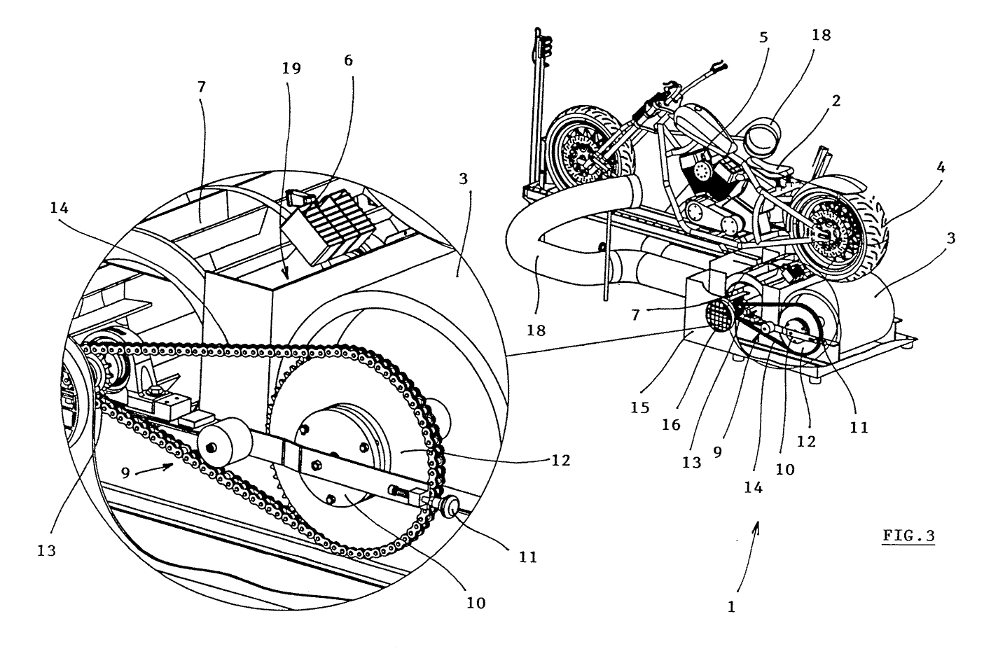

FIG. 3 shows a detailed representation of a gear with a higher gear ratio 9 which comprises a sprocket wheel 12 mounted on the axis of rotation of the fixed roller 3, a sprocket wheel 13 mounted on the axis of rotation of the fan 7 and the drive chain 14 mounted on both sprocket wheels 12 and 13. The difference between the diameters of the two sprocket wheels 12 and 13 is large, and therefore the rotation speed of the fan 7 is much higher than the rotation speed of the fixed roller 3. On the axis of rotation of the roller 3 there is a clutch 10 which is operated by a lever 11 for selecting the gear. The simple positioning of the lever 11 activates either the high range gear 9 or the low range gear 8.

The gear with lower gear ratio 8 and the gear with higher gear ratio 9 are located on opposite sides—bases—of the fixed roller 3 and the fan 7. In another design (not shown), they may be located on one common side of the fixed roller 3—at a single base.

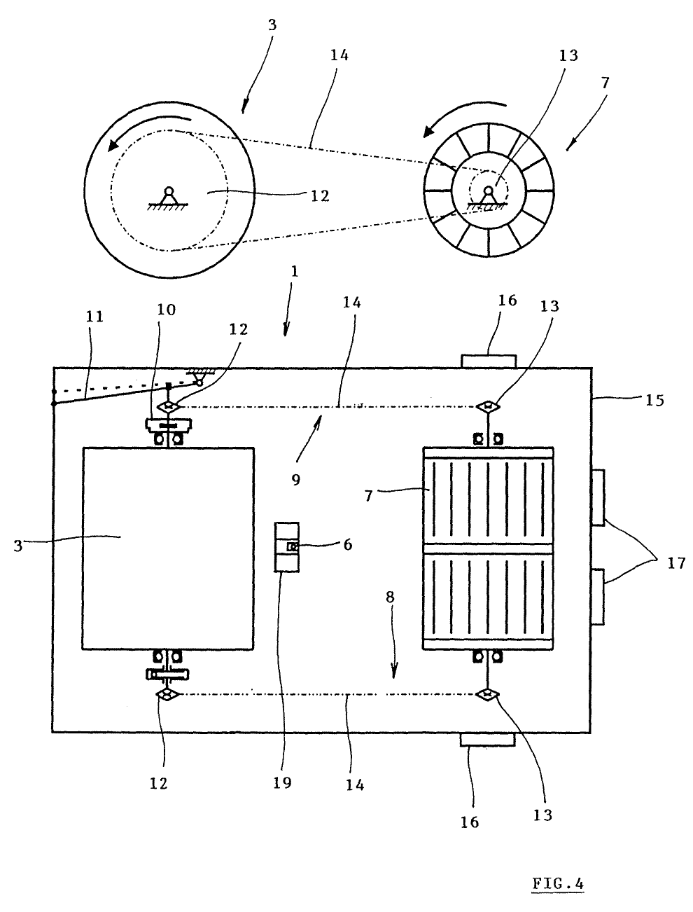

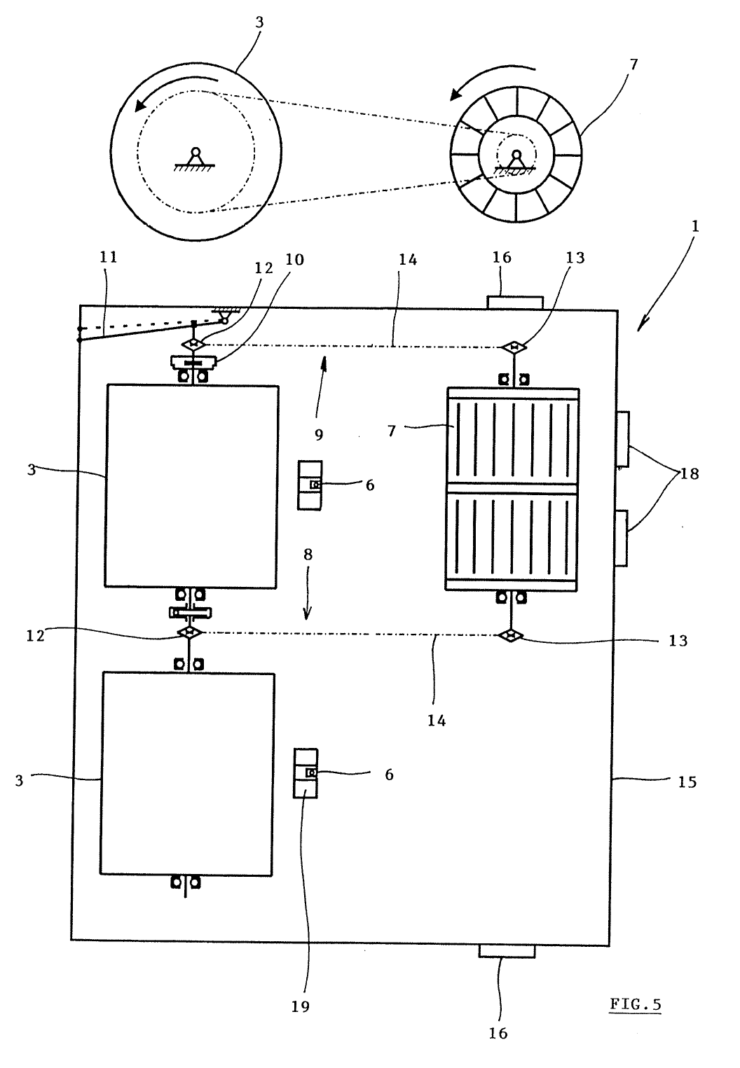

FIG. 4 shows an interconnection diagram of the fixed roller 3 with the fan 7 for a single-track motor vehicle 2. FIG. 5 shows a diagram for connecting two fixed rollers 3 for a two-track motor vehicle 2.

### INDUSTRIAL APPLICABILITY

The roller testing station according to the technical design can be used in motor vehicle service centers, in technical inspection stations for motor vehicles, and in mobile technical inspection stations operated by the traffic police.

### OVERVIEW OF THE POSITIONS USED IN THE DRAWINGS

1 roller testing station
2 motor vehicle
3 fixed roller
4 driven wheel
5 motor
6 sensor means
7 fan
8 clutch
9 gear with lower gear ratio
10 gear with higher gear ratio
11 gear selector lever
12 sprocket wheel on the axis of rotation of the fixed roller
13 sprocket wheel on the axis of rotation of the fan
14 drive chain
15 housing
16 suction opening
17 air outlet
18 pipe
19 air duct

1. A roller testing station for a motor vehicle comprising at least one fixed roller for rolling at least one driven wheel of the motor vehicle driven by a motor, at least one braking means, at least one cooling means for cooling the parts of the motor vehicle during the test, and at least one sensing means for monitoring and recording parameters and test results, wherein the braking means comprises at least one fan interconnected with the fixed roller by at least one of gear for transferring the rotational motion of the fixed roller to the fan.

2. The roller testing station according to claim 1, wherein two gears are formed with mutually different gear ratios, wherein the gear with the lower gear ratio and the gear with the higher gear ratio are switchable via a clutch provided with a lever for selecting the gear.

3. The roller testing station according to claim 2, wherein each of the gears comprises a sprocket wheel mounted on the axis of rotation of the fixed roller, a sprocket wheel mounted on the axis of rotation of the fan, and a drive chain.

4. The roller testing station according to claim 3, wherein in both the gears and, the sprocket wheels of the fixed roller have a larger diameter than the diameter of the sprocket wheels of the fan.

5. The roller testing station according to claim 1, wherein the fan is centrifugal, the fixed roller and the fan are arranged in parallel in a common housing, wherein the fixed roller partially extends from the housing for contact with the driven wheel of the motor vehicle and, perpendicular to the axis of rotation of the fan, there is formed, in the housing, at least one suction opening and further that in the housing there is provided at least one air outlet.

6. The roller testing station according to claim 5, wherein the cooling means comprises at least one pipe connected at one end to at least one air outlet, and at its other end is directed towards the motor of the motor vehicle.

7. The roller testing station according to claim 6, wherein the cooling means is further comprised of at least one air duct for guiding air, the inlet of which is arranged at the fan and whose outlet is arranged near the driven wheel.

8. The roller testing station according to claim 1, wherein the sensing means comprises at least one device from the following group: a tachometer for the fixed roller, an infrared thermometer for measuring the temperature of the tire of the driven wheel of the vehicle, an infrared thermometer for measuring the temperature of the motor, a tachometer for the motor of the vehicle, and a sensor for measuring the temperature of the intake air.

9. The roller testing station according to claim 8, wherein the infrared thermometer for measuring the temperature of the tire of the driven wheel of the vehicle is arranged near the fixed roller.

10. The roller testing station according to claim 1, wherein it is equipped with two fixed rollers for testing the power of a mechanically loaded motor for two-track motor vehicles.
